(19) United States
(12) Patent Application Publication
(10) Pub. No.: US 2007/0104039 A1
(43) Pub. Date: May 10, 2007

(54) Method, apparatus, and system for installing software

(75) Inventors: Dai-Young Shin, Yongin-si (KR); Keon-Young Cho, Yongin-si (KR); Soo-Yeun Joo, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/521,409

(22) Filed: Sep. 15, 2006

(30) Foreign Application Priority Data
Nov. 9, 2005 (KR) 2005-107132

(51) Int. Cl. G06F 9/445; G11B 21/08

(52) U.S. Cl. 369/30.05; 717/174

(57) ABSTRACT

A method, apparatus, and system for installing software that includes acquiring one or more predetermined software identifiers from an identifier storage medium connected to a computing device, and installing software titles, which belong to a plurality of software titles stored in a software storage medium and correspond to the acquired software identifiers, in the computing device.

### CROSS-REFERENCE TO RELATED APPLICATION

This application claims the benefit of Korean Patent Application No. 2005-107132 filed on Nov. 9, 2005 in the Korean Intellectual Property Office, the disclosure of which is incorporated herein by reference.

### BACKGROUND OF THE INVENTION

1. Field of the Invention

Aspects of the present invention relate to the installation of software and, more particularly, to a method, apparatus, and system for installing software, which acquire only software titles licensed to a user from a storage medium in which a plurality of software titles has been stored, and install the licensed software titles in the user's computing device.

2. Description of the Related Art

Generally, a purchaser of a computer purchases both hardware and software that is installed and operated in the hardware. For example, the software includes an Operating System (OS), device drivers, and application programs.

A computer manufacturing company forecasts the demands of computers and determines the specifications of hardware and software included in a computer through various analyses. Thereafter, the company manufactures or purchases hardware and software according to the determined specifications and assembles and installs the hardware and software. In this case, the computer manufacturing company stores application programs to be installed in a computer on a separate storage medium, such as a Compact Disk (CD), and then provides the storage medium to a consumer together with the computer.

Examples of computers and corresponding software storage mediums, which are provided in the above-described way, are shown in FIG. 1. As shown in FIG. 1, the types of software titles (i.e., Software A through H), which are stored in software storage media provided together with the computers, may differ from each other according to the computer model (i.e., Models A through C). For instance, Model A needs Software A, B, and C; Model B needs Software D and E; and Model C needs Software F, G, and H. Thus, different media are used for each model. Furthermore, even for the same computer model, a different type of software may be stored in each software storage medium according to a user's desires.

However, in the conventional technology, it is difficult to manufacture and manage storage media storing software titles corresponding to the users' desires or computer models because the users' desires and the computer models are diverse. For example, as the users' desires or the computer models change, storage media on which only specific software titles corresponding to the users' desires or computer models are stored become unnecessary. Accordingly, software storage media that are already manufactured may become unusable. Furthermore, since processes of manufacturing software storage media corresponding to respective computer models must be performed, the manufacturing efficiency of the software storage media is harmed in direct proportion to the increase in the number of different computer models.

### SUMMARY OF THE INVENTION

Aspects of the present invention provide a method, apparatus, and system for installing software, which distribute storage media in each of which pieces of software are integrally stored regardless of computer model, and provide identifiers appropriate to respective computer models, thereby increasing the efficiency of the manufacturing and management of the storage media.

According to an aspect of the present invention, there is provided a method of installing software, the method including acquiring one or more predetermined software identifiers from an identifier storage medium connected to a computing device; and installing software titles that belong to a plurality of software titles stored in a software storage medium and correspond to the acquired software identifiers, in the computing device.

According to another aspect of the present invention, there is provided a system for installing software, the system including a software storage medium storing a plurality of software titles; and a computing device searching for software titles that belong to the plurality of software titles and correspond to one or more predetermined software identifiers, and installing the found software titles.

According to yet another aspect of the present invention, there is provided an apparatus for installing software, the apparatus including an information identification module acquiring one or more predetermined software identifiers from an identifier storage medium connected to a computing device; and an installation module installing software titles that belong to a plurality of software titles stored in a software storage medium and correspond to the one or more acquired software identifiers, in the computing device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a conventional process of distributing software storage media;

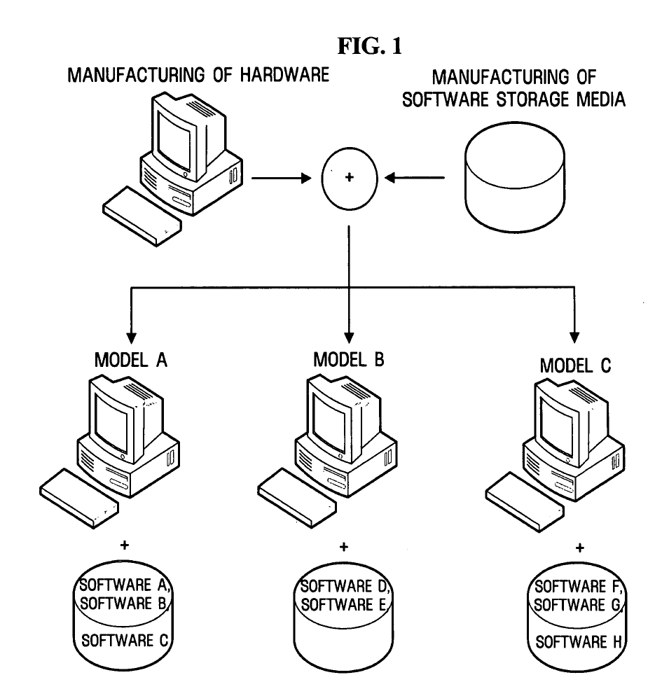

FIG. 2 is a diagram showing a system for installing software according to an embodiment of the present invention;

FIG. 3 is a diagram showing the configuration of a software storage medium according to an embodiment of the present invention;

FIG. 4 is a block diagram schematically showing the construction of a computing device according to an embodiment of the present invention;

FIG. 5 is a block diagram showing the construction of an apparatus for installing software according to an embodiment of the present invention;

FIG. 6 is a block diagram illustrating a method of installing software according to an embodiment of the present invention;

FIG. 7 is a diagram showing the installation of software according to an embodiment of the present invention;

FIG. 8 is a diagram showing the installation of software according to another embodiment of the present invention; and

FIG. 9 is a diagram showing the distribution of software storage media according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

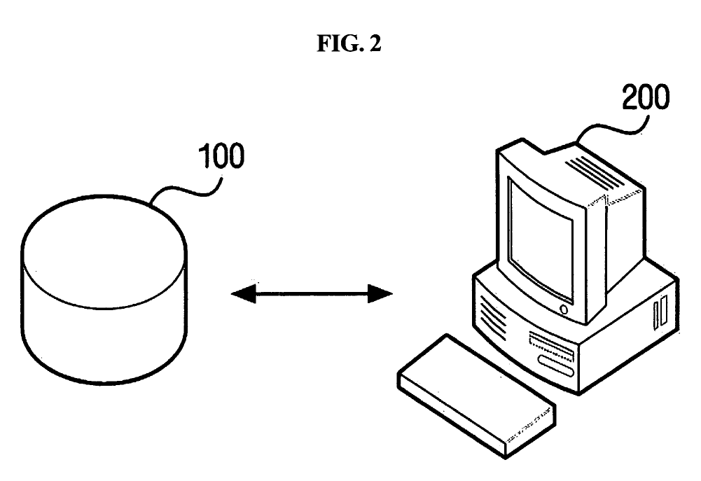

FIG. 2 is a diagram showing a system to install software according to an embodiment of the present invention. The software installation system, as shown in FIG. 2, includes a software storage medium 100 and a computing device 200.

The software storage medium 100 stores a plurality of software titles, and is a mobile storage medium that can be easily connected to and disconnected from the computing device 200. For example, the software storage medium 100 may be, but not limited to, a CD, a Digital Versatile Disk (DVD), a Universal Serial Bus (USB) storage device, flash memory, or the like. The software titles can be versions of a same title, software modules, or other like pieces of software.

When the software storage medium 100 is connected to the computing device 200, the computing device 200 installs software titles included in the plurality of software titles stored in the software storage medium 100 and for which installation authorization is respectively granted. In this case, and while not required in all aspects, the installation authorization is software identifiers and may be stored in the computing device 200 and/or a separate storage medium (not shown). Each of the software identifiers may, although not necessarily, have the form of a predetermined code or key value.

The storage software medium 100 can connect to and have data stored therein read by the computing device 200. Although not necessarily required in all aspects, the computing device 200 can be a desktop computer or a notebook computer, and is connected to the medium 100 through a physical electrical or wired connection or through a wireless medium. Detailed descriptions of the software storage medium 100 and the computing device 200 are made below.

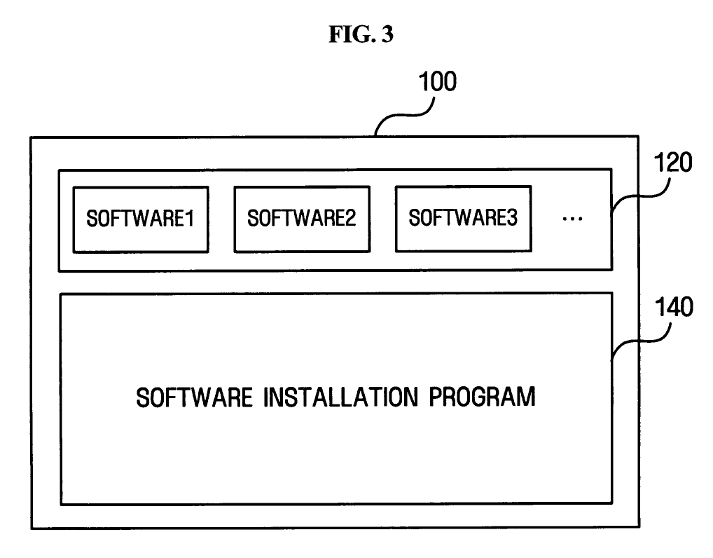

FIG. 3 is a diagram showing the configuration of a software storage medium 100 according to an embodiment of the present invention. The software storage medium 100 includes a plurality of software titles 120 and a software installation program 140.

The software titles 120 may be installed in the computing device 200 and may operate as various applications. For example, the pieces of software 120 may operate as applications for Office Automation (OA), Numeric Calculation, and games in the computing device 200. In more detail, the computing device 200 may provide a word processor, an image editor, and/or a moving image player by executing the software titles 120 stored on the medium 100 after installation.

The software installation program 140 is executed in the computing device 200 and functions to install software titles selected from among the plurality of software titles 120 in the computing device 200. When the software installation program 140 is executed in the computing device 200, one or more modules which install the software titles 120 may be executed, which will be described later. Meanwhile, although in FIG. 3 the software installation program 140 is shown in a single block form, this depiction does not imply that the software installation program 140 exists in a single program or file form in all aspects of the invention. As such, the software installation program 140 may be stored in the software storage medium 100 in the form of a plurality of files, programs, or sections of code. Additionally, while not required in all aspects, the program 140 can be written in a platform independent language such as Java to run on different operating systems.

In another embodiment of the present invention, the software installation program 140 may be stored in the computing device 200. For example, the software installation program 140 may be provided to a user in the state of having been stored on the hard disk of the computing device 200.

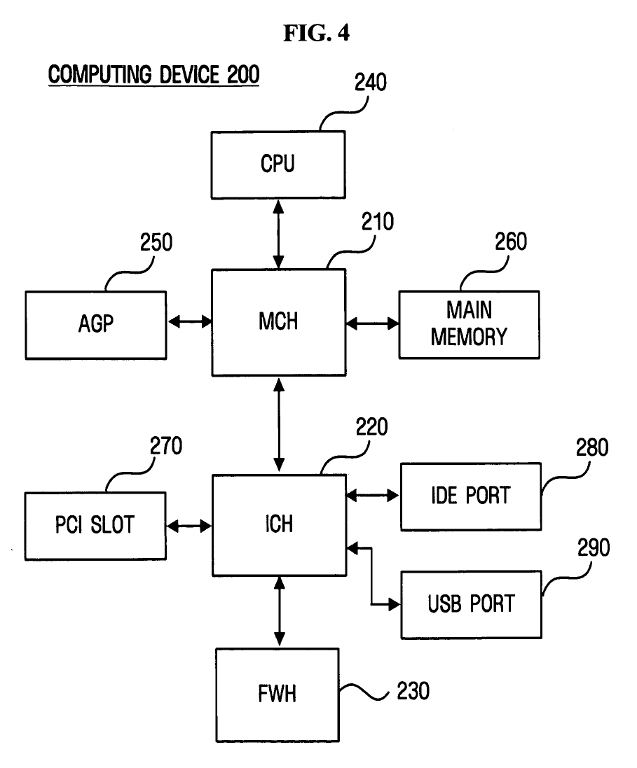

FIG. 4 is a block diagram schematically showing the construction of the computing device 200 according to an embodiment of the present invention. The computing device 200, as shown in FIG. 4, includes a Memory Controller Hub (MCH) 210, an Input/Output Controller Hub (ICH) 220, and a FirmWare Hub (FWH) 230. The elements may be integrated into a single chipset, and additional or fewer elements can be used in other aspects of the invention.

The MCH 210 controls devices having fast data transmission speed, such as a Central Processing Unit (CPU) 240, main memory 260, and an Accelerated Graphics Port (AGP) 250. The MCH 210 chiefly performs a memory access function, and enables the CPU 240 and the AGP 250 to access the main memory 260. Furthermore, the MCH 210 functions as a bridge or an interface to realize communication and transmit signals between one or more Input/Output (I/O) devices and the CPU 240, which can be connected to the ICH 220.

In an aspect of the invention, an AGP graphics card (not shown) is connected to the AGP 250. A video signal may be output to a display device, such as a monitor, through the AGP graphics card. Depending on the embodiment, a Graphic/Memory Controller Hub (GMCH) including the function of the AGP 250 may be used instead of the MCH 210 and the AGP 230.

The ICH 220 is connected to a Peripheral Component Interconnect (PCI) slot 270, an Integrated Drive Electronics (IDE) port 280, a USB port 290, or the like, and manages various I/O devices. In this example, boards (such as an LAN card, a modem, a video card, and a Small Computer System Interface (SCSI)), for which high-speed data transmission is required are connected to the PCI slot 270. Secondary memory units, such as a hard disk drive, a floppy disk drive, and a Compact Disk-Read Only Memory (CD-ROM) drive, are connected through the IDE port 280. Furthermore, the secondary memory units may be connected through the USB port 290. A representative example of a secondary memory unit is a USB storage device. It is understood that other connections are possible, such as through an IEEE 1394 port, a USB 2.0 port, and other like ports.

Peripheral devices, such as a keyboard, a mouse, and a memory device (for example, a USB storage device), may be connected to the USB port 290. The USB port 290 is used as a Plug and Play (PnP) interface between peripheral devices, such as a keyboard and a mouse, and the computing device 200. When a new peripheral device is connected while the computing device 200 is being used, the USB port 290 can automatically recognize the new peripheral device without a rebooting or set-up process and supply a power of 500 mA to each port. Therefore, the USB port 290 has a feature such that separate power is not necessary for devices, such as a mouse and a keyboard, that use low power. Thus, data transmission thereof is faster than that of a serial port even though the same principle as the serial port is applied thereto.

The FWH 230 is connected to the ICH 220, and provides firmware for controlling additional systems. In particular, the FWH 230 controls a boot sequence and stores commands and codes for inspecting the validity thereof. Meanwhile, the FWH 230 includes a BIOS (Basic Input Output System). The BIOS is an aggregation of routines for driving various I/O devices or peripheral devices, and includes a start-up routine and a hardware interrupt handling routine. The BIOS performs tasks, such as the booting of the computing device 200 and the loading of an OS, that are basically necessary to operate the computing device 200.

Where the software storage medium 100 is a CD or a DVD, the software storage medium 100 may be connected to the computing device 200 through the CD-ROM drive of the IDE port 280. Where the software storage medium 100 is a USB storage device, the software storage medium 100 may be connected to the computing device 200 through the USB port 290.

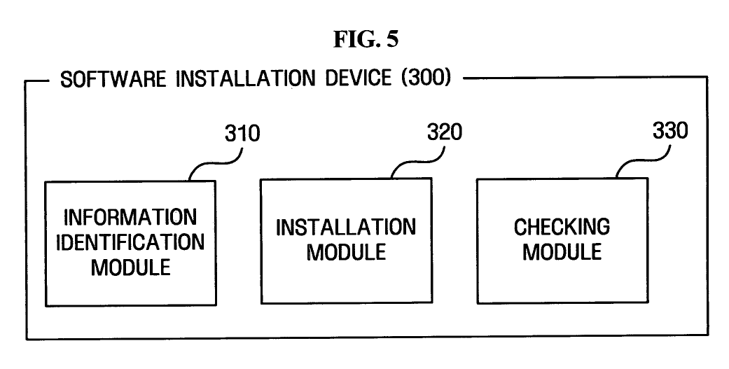

When the software storage medium 100 is connected to the computing device 200, the software installation program 140 is executed. The CPU 240 and the main memory 260 operate to execute the software installation program 140. The software installation program 140 may be automatically executed when the software storage medium 100 is connected to the computing device 200, or may be executed at a request from a user. As the software installation program 140 is executed, a task of installing predetermined software selected from among the plurality of software titles 120 stored in the software storage medium 100 is performed, which will be described with reference to FIG. 5.

FIG. 5 is a block diagram showing the construction of a software installation apparatus 300 for installing software according to an embodiment of the present invention. The software installation apparatus 300 shown in FIG. 5 may be generated and driven by the computing device 200. Specifically, when the software storage medium 100 is connected to the computing device 200, the software installation program 140 is executed on the main memory 260 by the CPU 240 of the computing device 200, so that the software installation apparatus 300 can be executed.

The software installation apparatus 300, as shown in FIG. 5, includes an information identification module 310, a checking module 330, and an installation module 320.

The information identification module 310 searches an identifier storage medium, and acquires software identifiers from the identifier storage medium. The identifier storage medium may, although not necessarily, be included in the computing device 200. For example, the identifier storage medium may be a specific region on the hard disk of the computing device 200 in which the change and addition of data are physically or logically prevented. Furthermore, the identifier storage medium may be Read-Only Memory (ROM). The ROM may be included in the FWH 230 shown FIG. 4 or connected thereto. However, the present invention is not limited thereto.

In another embodiment of the present invention, the identifier storage medium may be provided in a device separate from the computing device 200. For example, the identifier storage medium may be implemented using a floppy disk, flash memory, a USB storage device, or the like.

It is preferred, but not required, that the software identifiers stored in the identifier storage medium be logically or physically protected from data processing tasks, such as deletion, change, copy, and movement.

The software identifiers are used to identify software titles, the use of which is permitted to the user of the computing device 200. Such software identifiers may be provided to the user by a computing device provider who stores them in the identifier storage medium. Furthermore, the information identification module 310 may identify the language of an OS which is operating in the computing device 200 and software titles which are already installed in the computing device 200.

The installation module 320 selects one or more software titles that correspond to the software identifiers acquired by the information identification module 310. The installation module 320 selects the software titles from among the plurality of software titles 120 stored in the software storage medium 100. A list of selected software titles may be displayed on the monitor (not shown) of the computing device 200 for the user. Furthermore if, of the selected software titles, there are software titles that are already installed in the computing device 200 and identified by the information identification module 310, the user can be informed of this fact.

The installation module 320 may install the selected software titles in the computing device 200. The installation of the software titles may be automatically performed or may be performed at the user's request. Depending on the embodiment, when there is a plurality of software titles corresponding to respective countries, the installation module 320 may install software that conforms to the language of the OS in the computing device 200.

The checking module 330 restricts arbitrary access to the plurality of software titles 120 stored in the software storage medium 100. For example, if the user installs or copies a specific software title selected from among the plurality of software titles 120 stored in the software storage medium 100, the checking module 330 determines whether the selected software title is software corresponding to the software identifier. If, as a result of the determination, the selected software title is not the software title corresponding to the software identifier, the checking module 330 can prevent the selected software from being installed or copied.

As an embodiment for preventing access to the plurality of software titles 120 stored in the software storage medium 100, the software title may be packaged using the software identifiers (which is a kind of encryption task). In this case, only the use of software identifiers corresponding to respective software titles enables packaged original software to be acquired. In contrast, when there are no software identifiers, the packaged original software cannot be acquired.

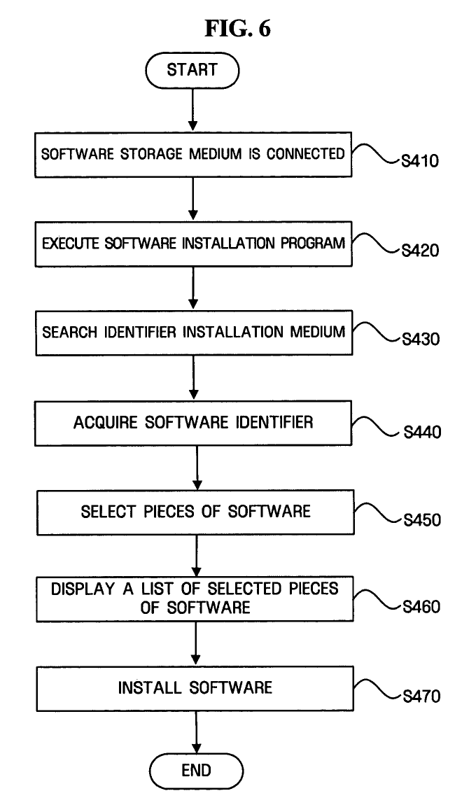

FIG. 6 is a block diagram illustrating a method of installing software according to an embodiment of the present invention. When the software storage medium 100 is connected to the computing device 200 at step S410, the CPU 240 of the computing device 200 executes the software installation program 140 at step S420. As a result of the execution, the software installation apparatus 300 described with reference to FIG. 5 is implemented. In this case, it is preferred, but not required, that the software installation program 140, as described with reference to FIG. 3, be stored in the software storage medium 100, but the present invention is not limited thereto. The software installation program 140, or portions thereof, may be stored in the computing device 200 in another aspect of the invention.

When the software installation apparatus 300 is implemented, the information identification module 310 searches the identifier storage medium at step S430. In this example, the information identification module 310 may identify the language of the OS that is operating in the computing device 200 and the software titles already installed in the computing device 200. However, it is understood that the identification can be otherwise, such as the language of a user, or other information used to distinguish one software title from another.

Meanwhile, the type of the storage medium to be used as the identifier storage medium may be set in advance. For example, if a CD or DVD is set as the identifier storage medium, the information identification module 310 may examine whether the CD or DVD has been inserted into the CD-ROM drive connected through the IDE port 280 of the computing device 200. Furthermore, if a USB storage device is set as the identifier storage medium, the information identification module 310 may examine whether the USB storage device has been connected through the USB port 290.

After the identifier storage medium has been ascertained, the information identification module 310 searches the identifier storage medium for software identifiers and acquires the found software identifiers at step S440. The software identifiers may be stored in the identifier storage medium in advance by a provider providing the computing device 200, according to the model of the computing device 200 or to the user's request.

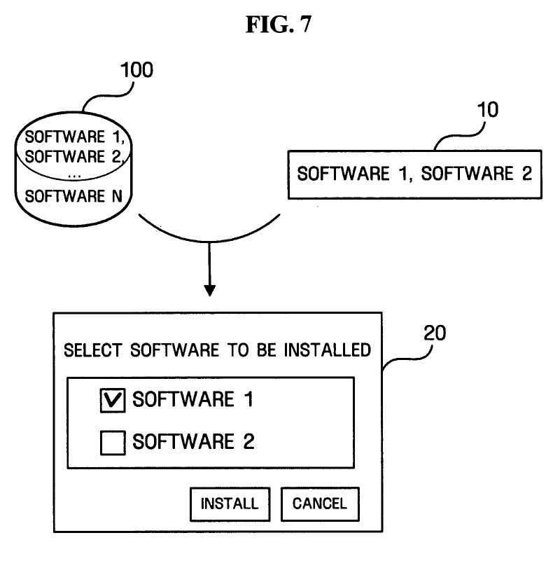

After the software identifier has been acquired, the installation module 320 selects software titles included in the plurality of software titles 120 in the software storage medium 100 corresponding to the software identifiers at step S450. The installation module 320 displays a list of selected software titles on the monitor (not shown) at step S460. For example, if, as shown in FIG. 7, n software titles have been stored in the software storage medium 100, but software identifiers for software 1 and software 2 have been stored in an identifier storage medium 10, a list including software 1 and software 2 can be viewed through a user monitor 20, and software to be installed can be selected from among the software 1 and the software 2. The software already installed in the computing device 200 installation may be displayed or highlighted using a predetermined color.

Thereafter, the installation module 320 installs the selected software titles in the computing device 200 at step S470. The installed software may be a software title included in the selected software titles and is selected by the user or may be automatically installed without the user's intervention.

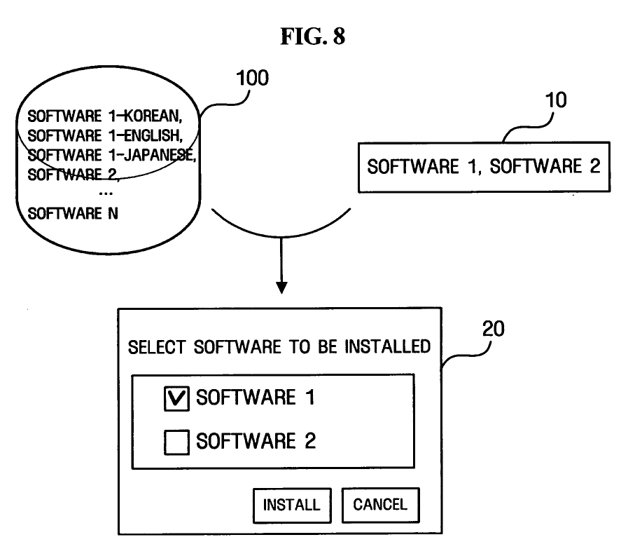

While not required in all aspects, a plurality of software titles and/or modules corresponding to a single identifier may be stored in the software storage medium 100. As shown in FIG. 8, the case where a Korean version, an English version, and a Japanese version of software 1 use the same software identifier is an example thereof. In this case, when the information identification module 310 identifies the language of the OS that is operating in the computing device 200 at step S470, the installation module 320 may automatically install software corresponding to the identified language without a separate request from the user.

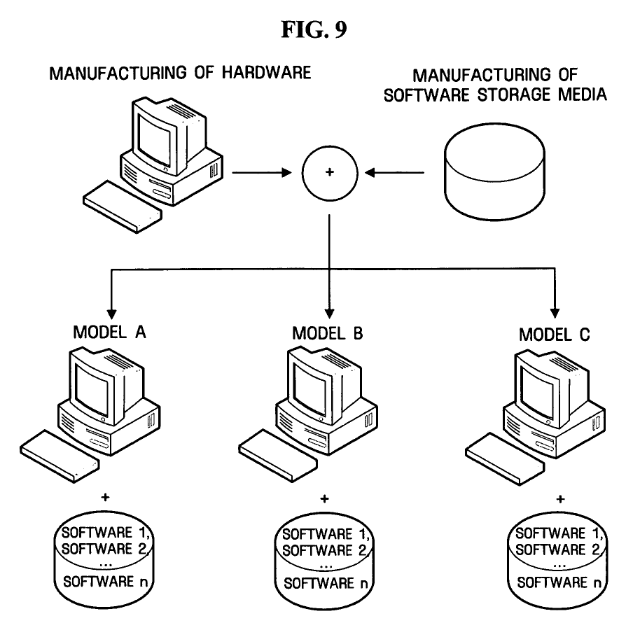

According to an aspect of the present invention described above and in FIG. 9, a computing device provider can completely manufacture and manage a software storage medium 100 that stores a plurality of software titles 120, regardless of the model of the computing device 200 or the requests of users. Thus, the software storage medium 100 can hold the same software 1 through n while installing only the appropriate software in different models A, B, C. Furthermore, the computing device provider can completely manage installing a variety of different software titles in the same model using the software storage medium 100. For example, computing device providers often sell the same computing device to different buyers, with a different arrangement of software titles installed in the device for each buyer. According to an aspect of the present invention, the computing device provider can provide the same software storage medium 100 holding the software 1 through n to all the buyers of the computing device, providing only the appropriate software identifiers with each device. As such, when the medium 100 is loaded into the device, the program 140 installs only the software corresponding to the particular model.

As described above, in accordance with the method, apparatus, and system for installing software of the present invention, a storage medium that completely stores a plurality of desired software titles is manufactured, so that the manufacture and management of the software storage media can be facilitated.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of installing software, the method comprising:
acquiring one or more predetermined software identifiers from an identifier storage medium connected to a computing device; and
installing, in the computing device, software titles selected from a plurality of software titles stored in a software storage medium and correspond to the acquired software identifiers.

2. The method as claimed in claim 1, wherein the installing of the software titles comprises:
accessing the software storage medium;
searching the software storage medium for the software titles corresponding to the acquired software identifiers; and
installing the found software titles in the computing device.

3. The method as claimed in claim 1, wherein the software identifiers are stored in the identifier storage medium by a provider of the computing device.

4. The method as claimed in claim 1, wherein the installing of the software titles comprises:
searching for the software titles that correspond to the acquired software identifiers and have already been installed in the computing device; and
installing the software titles, which, as a result of the searching, correspond to the acquired software identifiers and have not been installed in the computing device.

5. The method as claimed in claim 1, wherein the installing of the software titles comprises:
checking a language of an Operating System (OS) that is being operated by the computing device; and
installing, in the computing device, the software titles that belong to the plurality of the software titles stored in the software storage medium and correspond to the acquired software identifiers and the checked language.

6. The method as claimed in claim 1, further comprising displaying a list of the software titles corresponding to the acquired software identifiers.

7. The method as claimed in claim 6, further comprising selecting, by a user, the software titles to be installed in the computing device from the list of the software titles corresponding to the acquired software identifiers.

8. The method as claimed in claim 1, wherein the identifier storage medium is a storage medium secured to the computing device.

9. The method as claimed in claim 1, wherein the identifier storage medium is a mobile storage medium that can be connected to and disconnected from the computing device.

10. The method as claimed in claim 1 wherein the identifier storage medium is any one of a hard disk, Read-Only Memory (ROM), a floppy disk, flash memory, and a Universal Serial Bus (USB) storage device.

11. The method as claimed in claim 1, wherein the software storage medium is any one of a Compact Disk (CD), a Digital Versatile Disk (DVD), flash memory, and a USB storage device.

12. The method as claimed in claim 1, wherein the software storage medium is a storage medium provided in an inside area of the computing device.

13. The method as claimed in claim 1, further comprising:
preventing software titles that belong to the plurality of the software titles stored in the software storage medium but do not correspond to the acquired software identifiers from being copied or installed by a user.

14. The method as claimed in claim 1, wherein the identifier storage medium is write protected to prevent alteration of the predetermined software identifiers.

15. A system for installing software, the system comprising:
a software storage medium which stores a plurality of software titles; and
a computing device which searches for software titles selected from the plurality of the software titles and correspond to one or more predetermined software identifiers, and installs the found software titles.

16. The system as claimed in claim 15, wherein the computing device comprises an interface to make a connection with the software storage medium.

17. The system as claimed in claim 15, wherein the software storage medium is provided in an inside area of the computing device.

18. The system as claimed in claim 17, wherein the software storage medium is any one of a hard disk and ROM.

19. The system as claimed in claim 15, wherein the one or more predetermined software identifiers are stored in an identifier storage medium provided in an inside area of the computing device.

20. The system as claimed in claim 15, wherein the one or more predetermined software identifiers are stored in an identifier storage medium separate from the computing device, and the computing device comprises an interface to make a connection with the identifier storage medium.

21. The system as claimed in claim 15, wherein the computing device executes a software installation program to install the software titles of the software storage medium that correspond to the one or more predetermined software identifiers.

22. The system as claimed in claim 21, wherein the software storage medium stores the software installation program.

23. The system as claimed in claim 21, wherein the computing device stores the software installation program.

24. The system as claimed in claim 21, wherein the software installation program executes an information identification module to search for and acquire the one or more predetermined software identifiers, and the software installation program executes an installation module to select and install, in the computing device, the software titles that correspond to the one or more acquired software identifiers from the plurality of the software titles stored in the software storage medium.

25. The system as claimed in claim 24, wherein the information identification module identifies the language of an Operating System that is operating in the computing device and software titles that are previously installed in the computing device; and the installation module installs the software titles that correspond to the one or more acquired software identifiers and conform to the identified language of the operating system, and informs a user of the previously installed software titles if the information identification module identified the previously installed software titles.

26. The system as claimed in claim 24, wherein the installation module installs the software titles that correspond to the one or more acquired software identifiers from the plurality of the software titles stored in the software storage medium only at a user's request.

27. The system as claimed in claim 24, wherein the software installation program executes a checking module to restrict an arbitrary access to the plurality of software titles.

28. The system as claimed in claim 19, wherein the identifier storage medium is write protected to prevent alteration of the predetermined software identifiers.

29. An apparatus for installing software, the apparatus comprising:
an information identification module to acquire one or more predetermined software identifiers from an identifier storage medium connected to a computing device; and
an installation module to install, in the computing device, software titles selected from a plurality of software titles stored in a software storage medium and correspond to the one or more acquired software identifiers.

30. The apparatus as claimed in claim 29, wherein the information identification module identifies the language of an Operating System that is operating in the computing device and software titles that are previously installed in the computing device; and the installation module installs the software titles that correspond to the one or more acquired software identifiers and conform to the identified language of the operating system, and informs a user of the previously installed software titles if the information identification module identified the previously installed software titles.

31. The apparatus as claimed in claim 29, wherein the installation module installs the software titles that correspond to the one or more acquired software identifiers from the plurality of the software titles stored in the software storage medium only at a user's request.

32. The apparatus as claimed in claim 29, further comprising a checking module to restrict an arbitrary access to the plurality of software titles.

33. A computer-readable storage medium storing a plurality of software titles and a software installation program executed by a computer to utilize at least one software identifier stored on the computer and to install software titles selected from the plurality of software titles that correspond to the at least one software identifier retrieved from the computer, wherein the selected software titles are executable by the computer.

34. The computer-readable storage medium as claimed in claim 33, wherein software titles not selected from the plurality of software titles and not executable by the computer are executable on another computer comprising another software identifier.

35. The computer-readable storage medium as claimed in claim 34, wherein the software installation program is executable on the computer and the another computer.

36. The computer-readable storage medium as claimed in claim 33, wherein each of the software titles is for a common program modified for different computer models.

37. (canceled)

38. (canceled)

39. (canceled)
